(19) United States
(12) Patent Application Publication
(10) Pub. No.: US 2023/0059942 A1
(43) Pub. Date: Feb. 23, 2023

(54) SYSTEM AND METHOD FOR ACTUATING BATTERY POWER FOR A MOWER

(71) Applicant: Honda Motor Co., Ltd., Tokyo (JP)

(72) Inventor: Kyusang RO, Chapel Hill, NC (US)

(21) Appl. No.: 17/406,286

(22) Filed: Aug. 19, 2021

(51) Int. Cl. B60L 15/20; A01D 34/00; A01D 34/68; A01D 34/78; A01D 69/02; B60L 50/60

(52) U.S. Cl. CPC B60L 15/20; A01D 34/006; A01D 34/6806; A01D 34/78; A01D 69/02; B60L 50/60; A01D 2101/00

(57) ABSTRACT

A system and method for actuating battery power for a mower that include receiving an input through a battery status switch of the battery. The system and method also include inputting a battery actuation switch based on receiving the input through the battery status switch. The system and method additionally include supplying an electronic signal to a microprocessor of the battery to supply power to a motor controller of the mower based on the input of the battery actuation switch. The system and method further include supplying electrical voltage to a motor of the mower to operate the motor based on the power supplied to the motor controller from the battery.

### BACKGROUND

Currently there are some lawn mowers that may include a battery pack. Current configurations of these lawn mowers require the battery pack to be manually enabled to continually output an amount power at all times. The requirement to manually enable the battery pack may cause issues with respect to short circuiting the battery pack resulting in damage to the battery pack and/or components of the lawn mowers. For example, if an operator's hands are wet, short circuiting of the battery pack may result based on the manual enablement of the battery pack. Additionally, manually enabling the battery pack may constitute an additional, uncomfortable, and/or complicated step with respect to the enablement of lawn mowers that may be tedious for the operator.

### BRIEF DESCRIPTION

According to one aspect, a computer-implemented method for actuating battery power for a mower that includes receiving an input through a battery status switch of the battery and inputting a battery actuation switch based on receiving the input through the battery status switch. The battery actuation switch is configured on a bottom portion of the battery and is mechanically pushed inward to make contact between an upper portion of the battery actuation switch and a conductor element of the battery. The computer-implemented method also includes supplying an electronic signal to a microprocessor of the battery to supply power to a motor controller of the mower based on the input of the battery actuation switch. The computer-implemented method further includes supplying electrical voltage to a motor of the mower to operate the motor based on the power supplied to the motor controller from the battery.

According to another aspect, a system for actuating battery power for a mower that includes a battery that is configured to supply electrical voltage to components of the mower, wherein the battery includes a microprocessor that is configured to send signals to components of the battery based on actuation of the battery. The system also includes a battery actuation switch that is disposed within an opening that is located on a bottom portion of the battery and is configured to be mechanically pushed inward to make contact between an upper portion of the battery actuation switch and a conductor element of the battery to actuate the battery. An electronic signal is supplied to the microprocessor to supply power to a motor controller of the mower based on an input of the battery actuation switch and electrical voltage is supplied to a motor of the mower to operator the motor based on the power supplied to the motor controller from the battery.

According to yet another aspect, a non-transitory computer readable storage medium storing instruction that when executed by a computer, which includes a processor perform a method that includes receiving an input through a battery status switch of a battery and inputting a battery actuation switch based on receiving the input through the battery status switch. The battery actuation switch is configured on a bottom portion of the battery and is mechanically pushed inward to make contact between an upper portion of the battery actuation switch and a conductor element of the battery. The method also includes supplying an electronic signal to a microprocessor of the battery to supply power to a motor controller of a mower based on the input of the battery actuation switch. The method further includes supplying electrical voltage to a motor of the mower to operate the motor based on the power supplied to the motor controller from the battery.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1 is an illustrative view that illustrates a mower and components of the mower according to an exemplary embodiment of the present disclosure;

FIG. 2 is an illustrative view that illustrates a particular configuration of an operator control panel of the mower according to an exemplary embodiment of the present disclosure;

FIG. 3 is a schematic overview of a plurality of components of the mower according to an exemplary embodiment of the present disclosure;

FIG. 4A is a top view of an exemplary configuration of the battery according to an exemplary embodiment of the present disclosure;

FIG. 4B is a bottom view of an exemplary configuration of the battery according to an exemplary embodiment of the present disclosure;

FIG. 5A is an illustrative side profile schematic view of the battery according to an exemplary embodiment of the present disclosure;

FIG. 5B is an illustrative embodiment of the battery that is shown as received within a recessed space that is included within housing of the mower according to an exemplary embodiment of the present disclosure;

FIG. 6 is a schematic overview of electrical components of the battery according to an exemplary embodiment of the present disclosure;

FIG. 7 is a process flow diagram of a method for supplying electrical power flow to the motor controller of the mower according to an exemplary embodiment of the present disclosure;

FIG. 8 is a process flow diagram of an actuation of the battery and an operation of the mower according to an exemplary embodiment of the present disclosure; and

FIG. 9 is a process flow diagram of a method for actuating battery power for a mower according to an exemplary embodiment of the present disclosure.

### DETAILED DESCRIPTION

The following includes definitions of selected terms employed herein. The definitions include various examples and/or forms of components that fall within the scope of a term and that can be used for implementation. The examples are not intended to be limiting.

A “bus,” as used herein, refers to an interconnected architecture that is operably connected to transfer data between computer components within a singular or multiple systems. The bus may be a memory bus, a memory controller, a peripheral bus, an external bus, a crossbar switch, and/or a local bus, among others.

“Computer communication,” as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

An “input device,” as used herein may include devices for controlling different components, systems, and subsystems. The term “input device” includes, but it not limited to: push buttons, rotary knobs, ON/OFF controls, sliding controls, and the like. The term “input device” additionally includes graphical input controls that take place within a user interface which may be displayed by various types of mechanisms such as software and hardware based controls, interfaces, or plug and play devices.

A “processor,” as used herein, processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

A “memory,” as used herein may include volatile memory and/or nonvolatile memory. Non-volatile memory may include, for example, ROM (read only memory), PROM (programmable read only memory), EPROM (erasable PROM) and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

A “module,” as used herein, includes, but is not limited to, hardware, firmware, software in execution on a machine, and/or combinations of each to perform a function(s) or an action(s), and/or to cause a function or action from another module, method, and/or system. A module may include a software controlled microprocessor, a discrete logic circuit, an analog circuit, a digital circuit, a programmed logic device, a memory device containing executing instructions, and so on.

An “operable connection,” as used herein may include a connection by which entities are “operably connected”, is one in which signals, physical communications, and/or logical communications may be sent and/or received. An operable connection may include a physical interface, a data interface and/or an electrical interface.

An “output device,” as used herein may include devices that may derive from electronic components, systems, subsystems, and electronic devices. The term “output devices” includes, but is not limited to: display devices, and other devices for outputting information and functions.

A “value” and “level”, as used herein may include, but is not limited to, a numerical or other kind of value or level such as a percentage, a non-numerical value, a discrete state, a discrete value, a continuous value, among others. The term “value of X” or “level of X” as used throughout this detailed description and in the claims refers to any numerical or other kind of value for distinguishing between two or more states of X. For example, in some cases, the value or level of X may be given as a percentage between 0% and 100%. In other cases, the value or level of X could be a value in the range between 1 and 10. In still other cases, the value or level of X may not be a numerical value, but could be associated with a given discrete state, such as “not X”, “slightly x”, “x”, “very x” and “extremely x”.

### I. Sysyem Overview

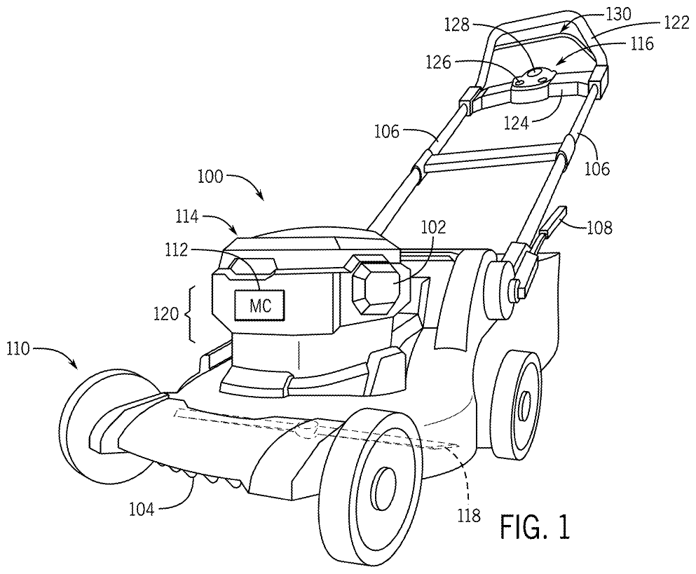

Referring now to the drawings, wherein the showings are for purposes of illustrating one or more exemplary embodiments and not for purposes of limiting the same, FIG. 1 is an illustrative view that illustrates a mower 100 (e.g., lawn mower) and components of the mower 100 according to an exemplary embodiment of the present disclosure. In an exemplary embodiment, the mower 100 may be configured as an electric lawn mower that may use electric motive power that is provided from a battery 102 of the mower 100. In an alternate embodiment, the mower 100 may be configured as a fuel powered mower (e.g., gasoline, fossil fuel) that may include an ignition control module (not shown) that may be provided electrical power from the battery 102 to enable an engine (not shown) of the mower 100. However, for purposes of simplicity, the battery 102 disclosed herein will be described with respect to the components of the mower 100 as an electrically operated mower that includes a plurality of components that are supplied with operating power from the battery 102 of the mower 100.

As shown in FIG. 1, the mower 100 may include a mower deck 104 of a body of the mower 100. The mower 100 also includes a foldable frame attachment 106 that is disposed upon the mower deck 104. The foldable frame attachment 106 may be configured to be foldable based on utilization of a folding switch 108. The foldable frame attachment 106 may be foldable to allow compact storage of the mower 100 (e.g., under a garage work bench). In particular, the folding switch 108 may be configured to be shifted from an unfolded position in which the foldable frame attachment 106 is unfolded (as shown in FIG. 1) to a folded position in which the foldable frame is folded above the mower deck 104 of the mower 100. Additionally, the foldable frame attachment 106 may be configured to be shifted from the folded position to the unfolded position based on the utilization of the folding switch 108. The mower deck 104 and the foldable frame attachment 106 are supported by a plurality of wheels 110 of the mower 100.

In an exemplary embodiment, the battery 102 of the mower 100 may provide power in the form of electrical voltage that is supplied to a motor controller 112 of the mower 100. In some embodiments, the motor controller 112 may include a microprocessor that may be configured to electronically control operation of a motor 114 (e.g., electrical motor) of the mower 100 and/or one or more additional electronic components of the mower 100. In addition to the microprocessor, the motor controller 112 may include one or more application-specific integrated circuit(s) (ASIC), or other similar devices.

The motor controller 112 may also include internal processing memory, an interface circuit, and bus lines for transferring data, sending commands, and communicating with the plurality of components of the mower 100. In one embodiment, the motor controller 112 may be configured to enable motive power to be supplied from the battery 102 to the motor 114 based on inputs received through an operator control panel 116 of the mower 100. In particular, the motor controller 112 may be configured to send and receive electronic signals to/from the operator control panel 116 that may receive inputs with respect to the actuation and operation of the mower 100 from an operator (not shown) (e.g., person operating the mower).

The motor controller 112 may operably control the motor 114 of the mower 100 by supplying electronic communication signals and a requisite amount of electrical power to operate a fan blade 118 of the mower 100 at one or more speeds based on operational inputs (e.g., pulling of a blade handle switch) by the operator through the operator control panel 116 of the mower 100. In other words, the motor 114 may be operably controlled to operate the fan blade 118 at one or more operational speeds based on an amount of electrical power that is supplied to the motor 114 by the motor controller 112. In some configurations, the motor 114 may also provide power to operate the wheels 110 of the mower 100 such that the wheels 110 may be mechanically operated to allow the mower 100 to progress forward upon a ground surface based upon voltage supplied from the battery 102.

In one embodiment, the battery 102, the motor controller 112, and the motor 114 may be contained within a housing 120 that is mounted upon the mower deck 104. As shown, the housing 120 may be configured in a particular shape that is configured to contain the battery 102, the motor 114, and the motor controller 112, in addition to electronic components and circuitry that operably and electronically connect the battery 102 to the motor controller 112 and the motor 114. The housing 120 may include a battery tray that may be configured to support the battery 102 within the housing 120. In alternate embodiments, the battery 102 may be included within a separate portion and/or a separate housing than the motor 114 and/or the motor controller 112. Accordingly, it is appreciated that the components of the mower 100 are shown in a schematized manner for clarity of view and that the configuration and arrangement of these components may vary from that shown.

In an exemplary embodiment, the mower 100 includes an operator handle (handle) 122 that may be disposed upon a top portion of the foldable frame attachment 106. Accordingly, the handle 122 may extend in a generally upright orientation when the foldable frame attachment 106 is in an unfolded position, as shown, to allow the operator to apply an operating force towards the handle 122. For example, the operator may provide an operating pushing force towards the handle 122 to move or partially move (e.g., with power provided by the motor 114) the wheels 110 along a ground surface (e.g., to mow a lawn).

As shown in FIG. 1, in one configuration of the mower 100, the foldable frame attachment 106 may include a cross member 124 that may be disposed adjacent to a lower portion of the handle 122. In some configurations, the cross member 124 may be configured to be movable to pivot towards or away from the operator. In alternative configurations, the cross member 124 may be disposed below the handle 122 or may be disposed upon or adjacent to an upper grasping portion of the handle 122 based on the configuration of the foldable frame attachment 106, the handle 122, and/or the cross member 124.

In one embodiment, the operator control panel 116 may be pivotally supported on the cross member 124. The operator control panel 116 may include a plurality of operator control inputs. The operator control inputs may be configured as physical input buttons, push bars, pull bars, display screen(s) with user interface input(s), and the like that may be inputted by the operator to actuate one or more functions of the mower 100.

In one configuration, the operator control panel 116 may be actuated by pivot of the cross member 124 towards the upper grasping portion of the handle 122. As should be understood, the depicted arrangement and configuration of the operator control panel 116 may facilitate the operator's grasping of the handle 122 while providing easy access to the plurality of operator control inputs of the operator control panel 116 located on the cross member 124 that is disposed adjacent to the handle 122.

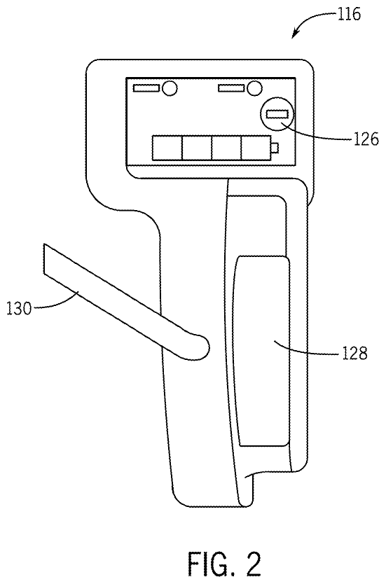

As shown in FIG. 2, in an alternate configuration, the mower 100 may include the operator control panel 116 in an alternate form factor. As shown, the operator control panel 116 of FIG. 2 may be configured as a panel that may be disposed upon a side bar of the foldable frame attachment 106 or the handle 122. The side configured operator control panel may also include the plurality of operator control inputs that may be inputted by the operator to actuate and/or utilize one or more functions of the mower 100 based on power supplied from the battery 102.

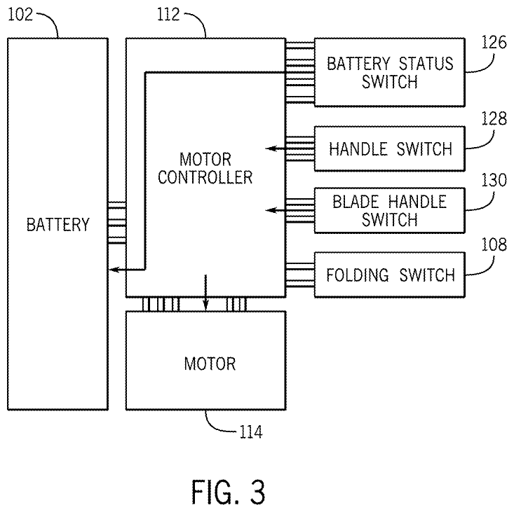

As shown in FIG. 1, FIG. 2, and FIG. 3, the plurality of operator control inputs of the operator control panel 116 may include and/or may be operably connected to, but may not be limited to, a battery status switch 126, a handle switch 128, and a blade handle switch 130. In one configuration, the battery status switch 126 may be configured as a push button that may disposed upon the operator control panel 116. In another configuration, the battery status switch 126 may be configured as a handle (e.g., push handle, pull handle) that may be pushed or pulled to be inputted by the operator of the mower 100. In some embodiments, the battery status switch 126 may include its own power source (e.g., rechargeable coin cell battery) (not shown) that may be utilized when the operator control panel 116 is not supplied power from the battery 102. This functionality may allow the battery status switch 126 to interpret received inputs and send inputs to actuate the battery 102 during disablement of the battery 102.

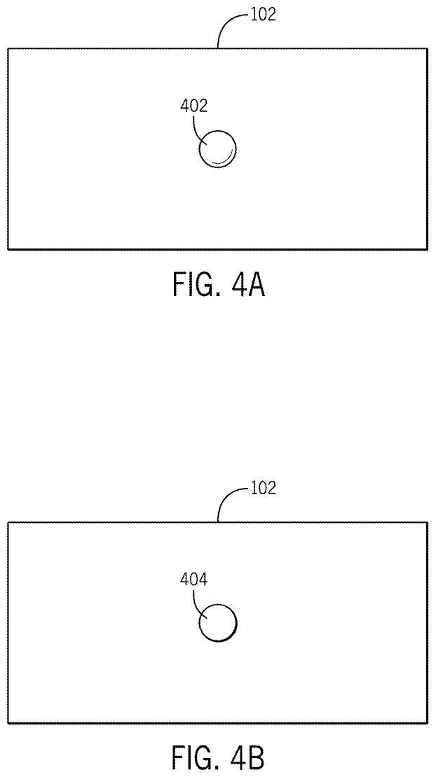

As discussed below, upon the receipt of a push input on the battery status switch 126, the battery 102 of the mower 100 may be mechanically actuated (e.g., enable, turn on) to provide electrical voltage to the components of the mower 100. In an exemplary embodiment, the battery 102 is configured to actuate without requiring manual enablement (by the operator) to provide power to the components of the mower 100. FIG. 4A shows a top view of an exemplary configuration of the battery 102 and FIG. 4B shows a bottom view of the exemplary configuration of the battery 102 (from FIG. 4A) shown in the removed condition from the mower 100 of FIG. 1. The battery 102 is depicted as having a rectangular configuration. However, the form factor, shape, and/or configuration of the battery 102, a top portion of the battery 102 (shown in the top view), and/or a bottom portion of the battery 102 (shown in the bottom view) may vary from that shown.

With continued reference to FIG. 4A and FIG. 4B, the battery 102 may include a battery indicator light 402 that is disposed upon the top portion of the battery 102 and a battery actuation switch 404 that is disposed upon the bottom portion of the battery 102. In one configuration, the battery indicator light 402 may be enabled to provide a lighting indication when the battery 102 has been actuated to provide electrical voltage based on pushing of the battery actuation switch 404 that is disposed on the bottom portion of the battery 102.

In an exemplary embodiment, the battery actuation switch 404 disposed upon on the bottom portion of the battery 102 may be configured to be mechanically pushed to enable the battery 102 to provide electrical voltage to the motor controller 112, the motor 114, and the operator control panel 116 based on an operator input of the battery status switch 126 included upon the operator control panel 116. As discussed in more detail below, the configuration of the battery actuation switch 404 of the battery 102 allows actuation of the battery 102 to be completed in a fail-safe manner that does not require any operator interaction with the battery 102.

This functionality minimizes the propensity of causing any short-circuiting issues with respect to the battery 102 and the components of the mower 100. Also, this functionally may ensure that the battery 102 is actuated in a manner such that it is not constantly discharging a voltage to the motor controller 112. For example, the battery 102 may operate to discharge 0V before being actuated based on the functionality of the battery actuation switch 404 and may provide voltage (e.g., 56V) after the battery actuation switch 404 is mechanically pushed.

Additionally, this functionality does not require the operator to physically actuate the battery 102 through the operator pushing or pulling any buttons and/or switches that are part of the battery 102 itself. Accordingly, the present disclosure provides an improvement in the technology by providing an input mechanism in the form of a battery switch button that may be mechanically engaged and inputted to enable the battery 102 from a disabled state to power the components of the mower 100 in a fail-safe manner that minimizes a likelihood of short-circuiting, direct operator interaction, and selectively provides voltage to the components of the mower 100.

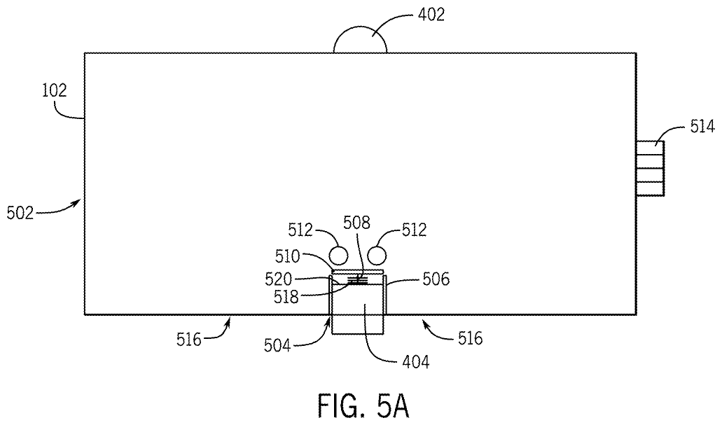

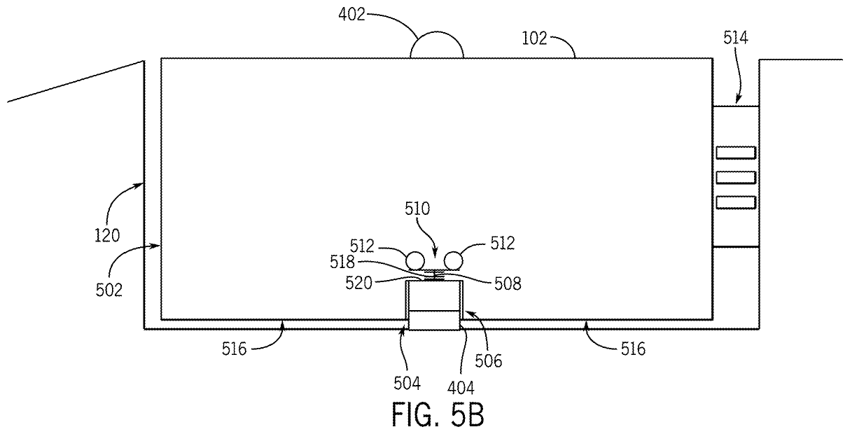

FIG. 5A is an illustrative side profile schematic view of the battery 102 according to an exemplary embodiment of the present disclosure. Similar to FIG. 4A and FIG. 4B, the side profile schematic view is depicted as having a rectangular configuration. However, the shape of the battery 102 may vary from that shown. As shown, the battery 102 may include a casing 502 that may be configured in one or more materials (e.g., injection molded plastics, polymers). The casing 502 of the battery 102 may contain the components of the battery 102.

As shown, the casing 502 of the battery 102 may be configured to include an opening 504 on a bottom portion of the battery 102. The opening 504 may include a width that is configured to allow the battery actuation switch 404 to be disposed within the opening 504. The opening 504 may also be configured to include a length that is configured to allow the battery actuation switch 404 to be vertically movable within the opening 504 such that the battery actuation switch 404 may project out from the opening 504 past a bottom most portion 516 of the casing 502. As discussed below, this functionality may allow the battery actuation switch 404 to be pushed inward towards a conductor element 510 to actuate the battery 102.

More specifically, when the battery actuation switch 404 is in a non-actuated position, a lower portion of the battery actuation switch 404 may project out of the opening 504 of the casing 502 such that a lower surface of the lower portion of the battery actuation switch 404 projects slightly beyond the bottom most portion 516 of the casing 502 of the battery 102. When the battery actuation switch 404 is in an actuated pushed position, the battery actuation switch 404 may be pushed inward towards the conductor element 510 such that the lower portion of the battery actuation switch 404 is flush with the bottom most portion 516 of the casing 502 and an upper portion of the battery actuation switch 404 contacts the conductor element 510. The conductor element 510 may be operably connected to electrical contacts 512 of the battery 102.

In an exemplary embodiment, the battery actuation switch 404 may be configured to be movable within a guide rib 506 that extends upwardly from the bottom most portion 516 of the casing 502. The guide rib 506 may be configured as a projecting rib that is configured to contact opposing sides of the battery actuation switch 404. In one configuration, the guide rib 506 may include guide rails that may be shaped to conform to the shape of the battery actuation switch 404. In some configurations, opposing sides of the battery actuation switch 404 may include openings (e.g., slits) that may be configured to allow the guide rails of the guide rib 506 to be inserted to guide the battery actuation switch 404 for vertical movement.

FIG. 5B includes an illustrative embodiment of the battery 102 that is shown as received within a recessed space (or battery receptacle) that is included within the housing 120 that is mounted upon the mower deck 104 of the mower 100. As shown in FIG. 5A and FIG. 5B, a plunger 508 may be located on an upper portion of the battery actuation switch 404. The plunger 508 may be operably connected to a spring 518 that may be associated with a switch electrical contact 520 that is disposed upon an upper portion of the battery actuation switch 404. The guide rib 506 may be sized such that contact forces between the guide rib 506 (e.g., caused by battery gravity loads during insertion of the battery 102 into the housing 120) may move the plunger 508 inwardly into the interior of the casing 502 towards the conductor element 510.

The guide rib 506 may be configured to allow contact between the plunger 508 and the spring 518. In other words, the battery actuation switch 404 may be pushed inwards to allow the spring 518 to be pushed to allow the switch electrical contact 520 disposed upon the upper portion of the battery actuation switch 404 to be pushed towards the conductor element 510 and to contact the conductor element 510 to actuate the battery 102. Additionally, the guide rib 506 and the spring 518 may allow the battery actuation switch 404 to retract back outwards to allow the battery actuation switch 404 to project slightly beyond the bottom most portion 516 of the casing 502 of the battery 102. The inclusion of the spring 518 between the plunger 508 and the conductor element 510 may provide for a continued contact between the conductor element 510 and the switch electrical contact 520.

In one embodiment, based on a reception of an operator input of the battery status switch 126, upon the touching of the bottom most portion 516 of the casing 502 upon an inside portion of the housing 120 that includes the battery tray, the battery actuation switch 404 may be pushed upward and may move upwards via the guide rib 506 to allow the plunger 508 to allow the spring 518 to contract such that there is continued contact between the conductor element 510 and the switch electrical contact 520 of the battery actuation switch 404.

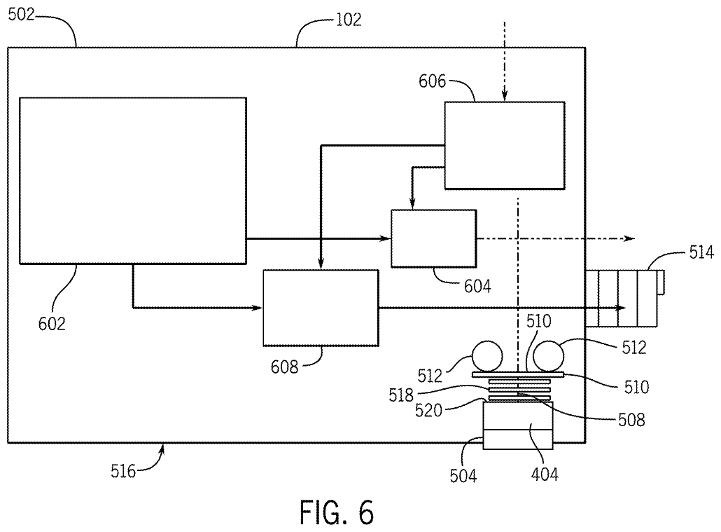

As discussed below, the electrical contacts 512 may be operably connected to internal components of the battery 102 including a battery cell (shown in FIG. 6) to allow electrical voltage to be supplied to the components of the mower 100 through an electrical contact element 514 that may project from a side portion of the casing 502 when contact occurs between the conductor element 510 and the switch electrical contact 520 of the battery actuation switch 404 based on the pushing in of the battery actuation switch 404. Accordingly, when the battery 102 is put into a battery tray located within the housing 120, the guide rib 506 will allow the battery status switch 126 to be pushed inward to actuate the battery 102 to provide electrical voltage through the electrical contact element 514 to the components of the mower 100.

FIG. 6 is a schematic overview of electrical components of the battery 102 that may each be electronically connected to one another through circuit elements (depicted as arrows) according to an exemplary embodiment of the present disclosure. As shown, the battery 102 may include a battery cell 602. The battery cell 602 may be configured to produce electrical voltage that may be provided from the battery 102. The battery cell 602 may be operably connected to microprocessor 604 of the battery 102 that may be configured to control the flow of electrical voltage between the battery cell 602 and the components of the mower 100 based on electrical voltage that is supplied through the electrical contact element 514 to the components of the mower 100.

In one embodiment, the microprocessor 604 is operably connected to a transistor 606 of the battery 102. The transistor 606 may be configured to provide a switching control function within the battery 102. In one configuration, the microprocessor 604 may be configured to enable the transistor 606 upon actuation of the battery 102 to supply electrical voltage to the operator control panel 116 of the mower 100. The microprocessor 604 may also be operably connected to a D-MOFSET element 608. The D-MOFSET element 608 may be configured as an electrical switch that may discharge current to supply electrical voltage.

The D-MOFSET element 608 may be configured to operate under higher levels of current than the transistor 606. Accordingly, the D-MOFSET element 608 may be enabled or disabled by the microprocessor 604 to supply electrical voltage through the electrical contact element 514 to thereby supply power to the motor controller 112 and the motor 114 of the mower 100. The current flow may thereby be sent from the motor controller 112 to provide motive power to the motor 114 to operate the fan blade 118 and/or the wheels 110 of the mower 100 at one or more speeds based on operational inputs that are provided by operator through the operator control panel 116 of the mower 100.

### II. Exemplary Methods Executed to Provide Power to the Components of the Mower

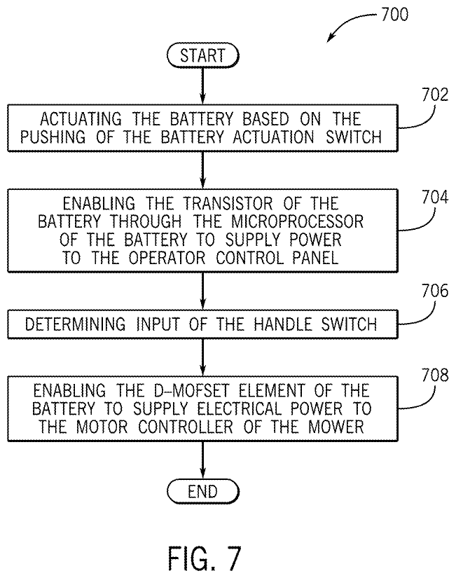

FIG. 7 is a process flow diagram of a method 700 for supplying electrical power flow to the motor controller 112 of the mower 100 according to an exemplary embodiment of the present disclosure. FIG. 7 will be described with reference to the components of FIG. 1-FIG. 6 though it is to be appreciated that the method 700 of FIG. 7 may be used with other systems/components.

The method 700 may begin at block 702, wherein the method 700 may include actuating the battery 102 based on the pushing of the battery actuation switch 404. In an exemplary embodiment, upon the touching of the bottom most portion 516 of the casing 502 upon an inside portion of the housing 120, the battery actuation switch 404 may be pushed upward and may move upwards via the guide rib 506 to allow the plunger 508 to allow the spring 518 to contract such that there is continued contact between the conductor element 510 and the switch electrical contact 520 of the battery actuation switch 404. As discussed above, the battery actuation switch 404 may be pushed inwards to allow the spring 518 to be pushed to allow the switch electrical contact 520 of the battery actuation switch 404 to be pushed towards the conductor element 510 and to contact the conductor element 510 to actuate the battery 102. Accordingly, the mechanical inward pushing of the battery actuation switch 404 may actuate the battery 102.

The method 700 may proceed to block 704, wherein the method 700 may include enabling the transistor 606 of the battery 102 through the microprocessor 604 of the battery 102 to supply power to the operator control panel 116. In one embodiment, upon actuation of the battery 102, the microprocessor 604 may be configured to send signals to the transistor 606 of the battery 102 to supply voltage through the electrical contact element 514 to supply power to the operator control panel 116. The power to the operator control panel 116 may enable the battery status switch 126, the handle switch 128, and the blade handle switch 130 to receive electrical power to interpret inputs and/or send electronic signals to the motor controller 112 and/or additional components of the battery 102.

The method 700 may proceed to block 706, wherein the method 700 may include determining input of the handle switch 128. In an exemplary embodiment, upon supplying power to the operator control panel 116, inputs may be interpreted by the handle switch 128 based on the operator providing a push input to the handle switch 128. Upon receiving the input to the handle switch 128, electronic signals may be sent to the microprocessor 604 of the battery 102.

The method 700 may proceed to block 708, wherein the method 700 may include enabling the D-MOFSET element 608 of the battery 102 to supply electrical power to the motor controller 112 of the mower 100. In one embodiment, upon receiving the electronic signals based on the input of the handle switch 128, the microprocessor 604 of the battery 102 may configured to enable D-MOFSET element 608 to discharge current to supply electrical voltage.

As discussed above, the D-MOFSET element 608 may be configured to operate under higher levels of current than the transistor 606. Accordingly, the D-MOFSET element 608 may be enabled to supply electrical voltage through the electrical contact element 514 to thereby supply power to the motor controller 112 of the mower 100. The current flow may thereby be sent from the motor controller 112 to provide motive power to the motor 114 to operate the fan blade 118 and/or the wheels 110 of the mower 100 at one or more speeds based on operational inputs that are provided by operator through the operator control panel 116 of the mower 100.

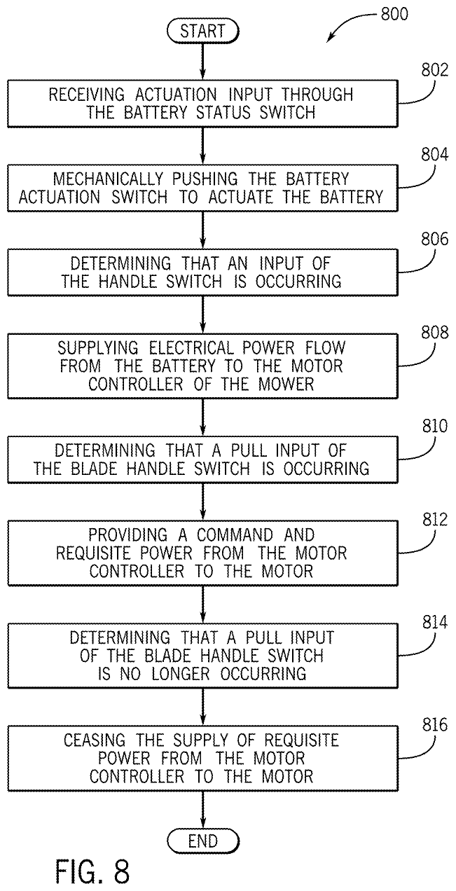

FIG. 8 is a process flow diagram of an actuation of the battery 102 and an operation of the mower 100 according to an exemplary embodiment of the present disclosure. FIG. 8 will be described with reference to the components of FIG. 1-FIG. 6 though it is to be appreciated that the method 800 of FIG. 8 may be used with other systems/components.

The method 800 may begin at block 802, wherein the method 800 may include receiving actuation input through the battery status switch 126. In one embodiment, inputs may be interpreted by the battery status switch 126 based on the operator providing an input to the battery status switch 126. In one configuration, the battery status switch 126 may include its own power source that may be utilized when the operator control panel 116 is not supplied power from the battery 102. This functionality may allow the battery status switch 126 to interpret received inputs and send inputs to actuate the battery 102 during disablement of the battery 102.

The method 800 may proceed to block 804, wherein the method 800 may including mechanically pushing the battery actuation switch 404 to actuate the battery 102. In an exemplary embodiment, upon reception of an operator input to the battery status switch 126, the bottom most portion 516 of the casing 502 may be configured to touch an inside portion of the housing 120. In particular, the lower portion of the battery actuation switch 404 may project out of the opening 504 of the casing 502 such that a lower surface of the lower portion of the battery actuation switch 404 projects slightly beyond the bottom most portion 516 of the casing 502 of the battery 102 to be pushed against the inside portion of the housing 120. The battery actuation switch 404 may be pushed inward towards the conductor element 510 such that the lower portion of the battery actuation switch 404 is flush with the bottom most portion 516 of the casing 502 and an upper portion of the battery actuation switch 404 contacts the conductor element 510.

In particular, the battery actuation switch 404 may be pushed upward and may move upwards via the guide rib 506 to allow the plunger 508 to allow the spring 518 to contract such that there is continued contact between the conductor element 510 and the switch electrical contact 520 of the battery actuation switch 404 to allow electrical voltage to be supplied. Accordingly, when the battery 102 is put into the battery tray located within the housing 120, the guide rib 506 will allow the battery status switch 126 to be pushed inward to actuate the battery 102 to provide electrical voltage through the electrical contact element 514 based on operation of the microprocessor 604 of the battery 102.

Upon actuation of the battery 102, the microprocessor 604 may be configured to send signals to the transistor 606 of the battery 102 to supply voltage through the electrical contact element 514 to supply power to the operator control panel 116. The power to the operator control panel 116 may enable the battery status switch 126, the handle switch 128, and the blade handle switch 130 to receive electrical power to interpret inputs and/or send electronic signals to the motor controller 112 and/or additional components of the battery 102.

The method 800 may proceed to block 806, wherein the method 800 may include determining that an input of the handle switch 128 is occurring. Upon actuation of the battery 102 and the supply of power from the transistor 606 to the operator control panel 116, inputs may be interpreted by the handle switch 128 based on the operator providing a push input to the handle switch 128. Upon receiving the input to the handle switch 128, electronic signals may be sent to the microprocessor 604 of the battery 102.

The method 800 may proceed to block 808, wherein the method 800 may include supplying electrical power flow from the battery 102 to the motor controller 112 of the mower 100. In an exemplary embodiment, upon receiving the electronic signals based on the input of the handle switch 128, the microprocessor 604 of the battery 102 may configured to enable D-MOFSET element 608 to discharge current to supply electrical voltage. Accordingly, the D-MOFSET element 608 may be enabled to supply electrical voltage through the electrical contact element 514 to thereby supply power to the motor controller 112 of the mower 100.

The method 800 may proceed to block 810, wherein the method 800 may include determining that a pull input of the blade handle switch 130 is occurring. In one embodiment, if the operator pulls upon the blade handle switch 130, electronic signals communicating the reception of the pull input may be sent to the microprocessor 604 of the battery 102 and the motor controller 112 of the mower 100. The electronic signals may include an amount of pulling that is occurring of the blade handle switch 130. In some configurations, a greater amount of pulling may correspond to a speed that the operator wishes to utilized with respect to the fan blade 118 and/or the wheels 110 of the mower 100.

The method 800 may proceed to block 812, wherein the method 800 may include providing a command and requisite power from the motor controller 112 to the motor 114. In an exemplary embodiment, upon receiving the electronic signals may include an amount of pulling that is occurring of the blade handle switch 130, the motor controller 112 may be configured to provide motive power to the motor 114. Accordingly, electric voltage supplied from the D-MOFSET element 608 through the electrical contact element 514 to the motor controller 112 of the mower 100 may be directed to the motor 114 to provide a requisite amount of motive power to the motor 114 to operate the fan blade 118 and/or the wheels 110 of the mower 100 at one or more speeds based on an amount of pulling of the blade handle switch 130 by the operator through the operator control panel 116 of the mower 100.

The method 800 may proceed to block 814, wherein the method 800 may include determining that a pull input of the blade handle switch 130 is no longer occurring. In one embodiment, if the operator ceases to pull the blade handle switch 130, electronic signals communicating the reception of the pull input may no longer be sent to the microprocessor 604 of the battery 102 and the motor controller 112 of the mower 100.

The method 800 may proceed to block 816, wherein the method 800 may include ceasing the supply of requisite power from the motor controller 112 to the motor 114. In one embodiment, upon determining that the pull input of the blade handle switch 130 is no longer provided, the motor controller 112 may cease providing motive power to the motor 114 to operate the fan blade 118 and/or the wheels 110 of the mower 100. In one configuration, upon the passage of a threshold amount of time (e.g., predetermined period of time of 120 seconds) the microprocessor 604 may send signals to the D-MOFSET element 608 to cease the supply of electric voltage from the D-MOFSET element 608 through the electrical contact element 514 to the motor controller 112 of the mower 100. The microprocessor 604 may thereby disable the battery 102. Accordingly, the battery 102 may be actuated again based on the reception of the actuation input through the battery status switch 126 (as discussed at block 802).

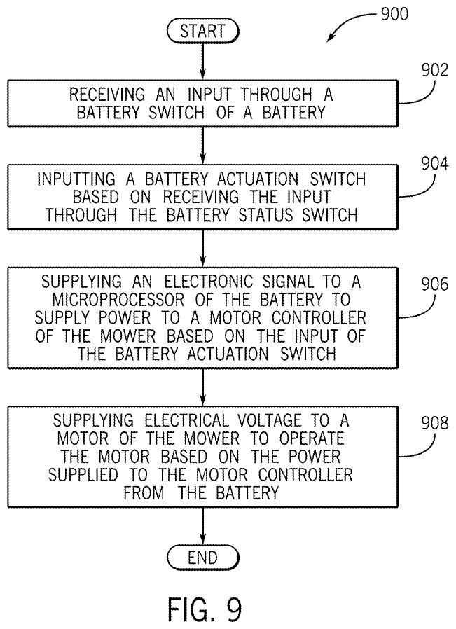

FIG. 9 is a process flow diagram of a method 900 for actuating battery power for a mower according to an exemplary embodiment of the present disclosure. FIG. 9 will be described with reference to the components of FIG. 1-FIG. 6 though it is to be appreciated that the method 900 of FIG. 9 may be used with other systems/components.

The method 900 may begin at block 902, wherein the method 900 may include receiving an input through a battery status switch 126 of the battery 102. The method 900 may proceed to block 904, wherein the method 900 may include inputting a battery actuation switch 404 based on receiving the input through the battery status switch 126. In one embodiment, the battery actuation switch 404 is configured on a bottom portion of the battery 102 and is mechanically pushed inward to make contact between an upper portion of the battery actuation switch 404 and a conductor element 510 of the battery 102.

The method 900 may proceed to block 906, wherein the method 900 may include supplying an electronic signal to a microprocessor 604 of the battery 102 to supply power to a motor controller 112 of the mower 100 based on the input of the battery actuation switch 404. The method 900 may proceed to block 908, wherein the method 900 may include supplying electrical voltage to a motor 114 of the mower 100 to operate the motor 114 based on the power supplied to the motor controller 112 from the battery 102.

It should be apparent from the foregoing description that various exemplary embodiments of the disclosure may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A machine-readable storage medium may include any mechanism for storing information in a form readable by a machine, such as a personal or laptop computer, a server, or other computing device. Thus, a non-transitory machine-readable storage medium excludes transitory signals but may include both volatile and non-volatile memories, including but not limited to read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

It will be appreciated that various implementations of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A computer-implemented method for actuating battery power for a mower, comprising:
receiving an input through a battery status switch of the battery;
inputting a battery actuation switch based on receiving the input through the battery status switch, wherein the battery actuation switch is configured on a bottom portion of the battery and is mechanically pushed inward to make contact between an upper portion of the battery actuation switch and a conductor element of the battery;
supplying an electronic signal to a microprocessor of the battery to supply power to a motor controller of the mower based on the input of the battery actuation switch; and
supplying electrical voltage to a motor of the mower to operate the motor based on the power supplied to the motor controller from the battery.

2. The computer-implemented method of claim 1, wherein the battery status switch is disposed upon an operator control panel of the mower, wherein the operator control panel includes a plurality of additional inputs that are used to operably control functions of the mower.

3. The computer-implemented method of claim 2, wherein the battery actuation switch is associated with a spring and a guide rib that are configured to enable the battery operation switch to move and touch a portion of a housing of the mower to input the battery power switch.

4. The computer-implemented method of claim 3, wherein inputting the battery actuation switch includes pushing the battery actuation switch inwards based on guidance of the guide rib and contracting of the spring, wherein the spring is operably connected to a plunger.

5. The computer-implemented method of claim 4, wherein inputting the battery actuation switch includes moving the plunger inwardly to move the battery actuation switch upwards based on physical contact between a bottom portion of the battery actuation switch and the portion of the housing of the mower.

6. The computer-implemented method of claim 5, wherein supplying the electronic signal includes guiding the battery actuation switch to move upwardly to enable a switch electrical contact disposed upon the upper portion of the battery actuation switch to contact the conductor element of the battery to actuate the battery.

7. The computer-implemented method of claim 5, wherein the conductor element of the battery is operably connected to electrical contacts of the battery, wherein the electrical contacts of the battery are operably connected to a battery cell of the battery that is configured to produce electrical voltage that is provided from the battery to the mower upon actuation of the battery.

8. The computer-implemented method of claim 5, further including controlling a transistor of the battery to supply electrical voltage to the operator control panel to interpret inputs and send electronic signals to the battery and motor controller of the mower to control functions of the mower.

9. The computer-implemented method of claim 8, wherein supplying the electrical voltage to the motor includes controlling a D-MOFSET element of the battery to supply electrical voltage to the motor controller of the mower to provide motive power to the motor of the mower upon receiving a pull input of a handle switch operably connected to the operator control panel.

10. A system for actuating battery power for a mower, comprising:
a battery that is configured to supply electrical voltage to components of the mower, wherein the battery includes a microprocessor that is configured to send signals to components of the battery based on actuation of the battery; and
a battery actuation switch that is disposed within an opening that is located on a bottom portion of the battery and is configured to be mechanically pushed inward to make contact between an upper portion of the battery actuation switch and a conductor element of the battery to actuate the battery, wherein an electronic signal is supplied to the microprocessor to supply power to a motor controller of the mower based on an input of the battery actuation switch and electrical voltage is supplied to a motor of the mower to operator the motor based on the power supplied to the motor controller from the battery.

11. The system of claim 10, wherein a battery status switch is disposed upon an operator control panel of the mower and the battery actuation switch is mechanically inputted based on receiving an input through the battery status switch, wherein the operator control panel includes a plurality of additional inputs that are used to operably control functions of the mower.

12. The system of claim 11, wherein the battery actuation switch is associated with a spring and a guide rib that are configured to enable the battery operation switch to move and touch a portion of a housing of the mower to input the battery power switch.

13. The system of claim 12, wherein the battery actuation switch is configured to be pushed inwards based on guidance of the guide rib and contracting of the spring, wherein the spring is operably connected to a plunger.

14. The system of claim 13, wherein the guide rib extends upwardly from a bottom most portion of a casing of the battery and is configured to guide an upward movement of the battery actuation switch inwardly into an interior of a casing of the battery based on contact between the bottom portion of the battery actuation switch and the portion of the housing of the mower.

15. The system of claim 13, wherein the guide rib and the spring allow a switch electrical contact disposed upon the upper portion of the battery actuation switch to contact the conductor element of the battery to actuate the battery.

16. The system of claim 13, wherein the conductor element of the battery is operably connected to electrical contacts of the battery, wherein the electrical contacts of the battery are operably connected to a battery cell of the battery that is configured to produce electrical voltage that is provided from the battery to the mower upon actuation of the battery.

17. The system of claim 13, wherein the microprocessor of the battery is operably connected to a transistor of the battery, wherein the microprocessor controls the transistor of the battery to supply electrical voltage to the operator control panel to interpret inputs and send electronic signals to the battery and motor controller of the mower to control functions of the mower.

18. The system of claim 17, wherein the microprocessor of the battery is operably connected to D-MOFSET element of the battery, wherein the microprocessor controls the D-MOFSET element of the battery to supply electrical voltage to the motor controller of the mower to provide motive power to the motor of the mower upon receiving a pull input of a handle switch operably connected to the operator control panel.

19. A non-transitory computer readable storage medium storing instruction that when executed by a computer, which includes a processor perform a method, the method comprising:
receiving an input through a battery status switch of a battery;
inputting a battery actuation switch based on receiving the input through the battery status switch, wherein the battery actuation switch is configured on a bottom portion of the battery and is mechanically pushed inward to make contact between an upper portion of the battery actuation switch and a conductor element of the battery;
supplying an electronic signal to a microprocessor of the battery to supply power to a motor controller of a mower based on the input of the battery actuation switch; and
supplying electrical voltage to a motor of the mower to operate the motor based on the power supplied to the motor controller from the battery.

20. The non-transitory computer readable storage medium of claim 19, wherein supplying the electrical voltage to the motor includes controlling a D-MOFSET element of the battery to supply electrical voltage to the motor controller of the mower to provide motive power to the motor of the mower upon receiving a pull input of a handle switch operably connected to an operator control panel of the mower.
